(19) United States
(12) Patent Application Publication
(10) Pub. No.: US 2019/0115750 A1
(43) Pub. Date: Apr. 18, 2019

(54) Electronic device with output energy limiting function

(71) Applicant: GETAC TECHNOLOGY CORPORATION, HSINCHU COUNTY (TW)

(72) Inventors: Ming-Zong Wu, Taipei City (TW); Min-Tai Chen, Taipei City (TW)

(21) Appl. No.: 15/783,982

(22) Filed: Oct. 13, 2017

(51) Int. Cl. H02H 9/00

(52) U.S. Cl. CPC H02H 9/008

(57) ABSTRACT

An electronic device with an output energy limiting function includes a system circuit, a thermal reactive element, a connection port, a current limiting element, and at least one diode series circuit. A first terminal of the thermal reactive element is coupled to the system circuit. The current limiting circuit is coupled between a second terminal of the thermal reactive element and the connection port. The at least one diode series circuit is coupled between the second terminal of the thermal reactive element and a ground voltage.

### BACKGROUND OF THE INVENTION

### Field of the Invention

The present invention relates to an intrinsic safety protection technology, and more particularly, to an electronic device with an output power limiting function.

### Description of the Prior Art

In general, in an internal of an electronic device under normal conditions, minute sparks may be produced due to issues of a switch circuit, a motor brush, a connector or other components, or a temperature may unusually rise under an abnormal condition, e.g., a short circuit.

If the electronic device is applied in a safe environment, such minute sparks and temperature rise (with the temperature being insufficient for causing damages such as an explosion of the electronic device) are acceptable. However, when the electronic device is applied in a hazardous environment, e.g., an environment with dangerous factors such as flammables and explosive gases, these minute sparks and the temperature rise may release energy sufficient for igniting the dangerous factors such as flammables, explosive gases and dusts in the environment, and thus the occurrence of such minute sparks and temperature rise is strictly not permitted.

Therefore, it is a critical task of the technical field as how to limit the output energy of an electronic device so as to prevent the electronic device from outputting an excessively high energy that may ignite the dangerous factors such as flammables, explosive gases and dusts in the environment, to further achieve intrinsic safety protection.

A fundamental theory of intrinsic safety is ensuring both electric energy and heat energy in a system are kept low enough that they do not cause combustion of explosive gases. Thus, in hazardous areas, only predetermined voltage and current (energy) are permitted, and energy storage is also strictly regulated.

One most common protection method is using resistors connected in series to limit a current flowing through (assuming that an open circuit is caused when the resistor malfunctions), and a thermal reactive element coupled to a Zener diode is also used to couple to a ground voltage to limit the voltage (assuming that a short circuit is caused when the Zener diode malfunctions). However, using a Zener diode on a path of high-speed transmission undesirably affects the signal transmission quality due to the high-capacitance characteristic of the Zener diode.

### SUMMARY OF THE INVENTION

In one embodiment, an electronic device with an output energy limiting function includes a system circuit, a thermal reactive element, a connection port, a current limiting element and at least one diode series circuit. A first terminal of the thermal reactive element is coupled to the system circuit. The current limiting element is coupled between a second terminal of the thermal reactive element and the connection port. The at least one diode is coupled between the second terminal of the thermal reactive element and a ground voltage.

In conclusion, the electronic device with an output power limiting function according to the embodiment of the present invention uses the diode series circuit having a low-capacitance characteristic, the current limiting unit and the thermal reactive element to limit the output energy of the connection port, enabling the electronic device to achieve the standard for intrinsic safety protection. Moreover, the diode series circuit having a low-capacitance characteristic further enhances the signal transmission quality between the connection port and the system circuit of the electronic device.

Detailed features and advantages of the present invention are given in detail in the following embodiments to one person skilled in the art to understand and accordingly implement the technical contents of the present invention. According to the contents, claims and drawings disclosed by the application, one person skilled in the art can easily understand the objects and advantages associated with the present invention.

### BRIEF DESCRIPTION OF THE DRAWINGS

FIG. 1 is a block diagram of an electronic device according to an embodiment;

FIG. 2 is a schematic diagram of a transmission port, applying a USB 2.0 transmission interface, of an electronic device according to an embodiment; and

FIG. 3 is a schematic diagram of a transmission port, applying a SIM transmission interface, of an electronic device according to an embodiment.

### DETAILED DESCRIPTION OF THE EMBODIMENTS

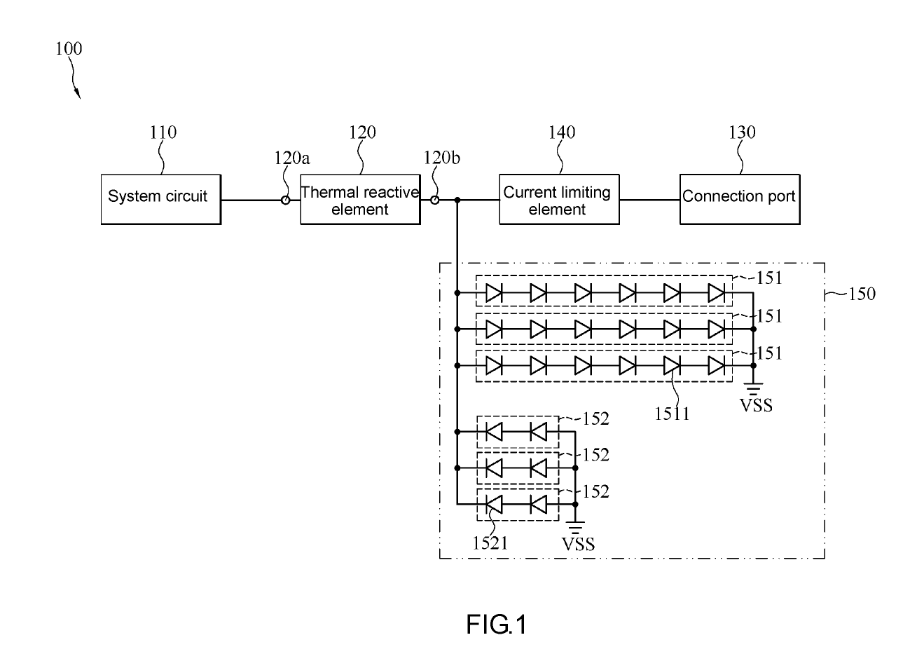

FIG. 1 shows a block diagram of an electronic device according to an embodiment of the present invention. Referring to FIG. 1, an electronic device 100 having an output power limiting function includes a system circuit 110, a thermal reactive element 120, a connection port 130, a current limiting element 140, and at least one diode series circuit 150. The combination of the thermal reactive element 120, the current limiting circuit 140 and the at least one diode series circuit 150 may be referred to as an intrinsic safety protection circuit of the electronic device 100. In the description below, one diode series circuit 150 is taken as an example for illustrations, but the number of the diode series circuit is not limited to this exemplary number.

The thermal reactive element 120 has a first terminal 120a and a second terminal 120b. The system circuit 110 is coupled to the first terminal 120a of the thermal reactive element 120. The current limiting element 140 is coupled between the second terminal 120b of the thermal reactive element 120 and the connection port 130. The diode series circuit 150 is coupled between the second terminal 120b of the thermal reactive element 120 and a ground voltage VSS.

The thermal reactive element 120 and the diode series circuit 150 coupled to connecting wire to the second terminal 120b of the thermal reactive element 120 serve as a voltage suppressing circuit. The current limiting circuit 140 is connected in series to the connection port 130, so as to prevent overloading or unexpected damages from occurring in the system circuit 110 due to an external short circuit. Such overloading and unexpected damages may cause an excessively large energy due to a high voltage or a large current on the connection port 130, in a way that substances, such as flammables, flammable gases and dusts, in a hazardous environment are ignited, eventually resulting in disasters jeopardizing life and properties.

For example, when an over-voltage occurs at the first terminal 120a or the second terminal 120b of the thermal reactive element 120, the diode series circuit 150 is forward conducted towards the ground voltage VSS. However, if the above situation persists for a period of time and a breaking capacity of the thermal reactive element 120 is reached, the thermal reactive element 120 breaks the electrical connection between the first terminal 120a and the second terminal 120b, so as to eliminate the over-voltage by the open circuit formed.

In some embodiments, the thermal reactive element 120 may be a non-regressive thermal reactive element, e.g., a non-resettable fuse element, in which the electrical connection between the first terminal 120a and the second terminal 120b cannot be restored after the electrical connection is melted and disconnected. However, the present invention is not limited to the above example. In some other embodiments, the thermal reactive element 120 may be a regressive thermal reactive element, e.g., a resettable fuse element, a dual-metal element or a shape memory alloy, in which the electrical connection between the first terminal 120a and the second terminal 120b can be restored after having been disconnected. Further, the thermal reactive element 120 may also be a combination of a non-regressive thermal reactive element and a regressive thermal reactive element.

When the connection port 130 encounters an external short circuit or abnormal use, the current limiting element 140 limits a current flowing through the connection port 130 and suppresses the energy generated on the connection port 130 exposed in a hazardous environment, such that the energy is insufficient for igniting substances in the hazardous environment and hence from causing dangers. For example, when the connection port 130 subsequent to the current limiting element 140 encounters a ground situation or a voltage difference, the current limiting element 140 can limit the current within a safe range.

In some embodiments, the current limiting element 140 may be a current limiting resistor. However, the present invention is not limited thereto. The current limiting element 140 may also be a current limiting circuit formed by an operational amplifier (OPA) or other appropriate elements.

The diode series circuit 150 can suppress an over-voltage occurring at the second terminal 120b of the thermal reactive element 120. For example, when an over-voltage occurs at the second terminal 120b of the thermal reactive element 120, the diode series circuit 150 clamps the over-voltage at a safe level.

In one embodiment, the diode series circuit 150 includes at least a forward-conduction circuit 151 and at least one reverse-conduction circuit 152. The forward-conduction circuit 151 and the reverse-conduction circuit 152 are coupled between the second terminal 120b of the thermal reactive element 120 and the ground voltage VSS. Each forward-conductive circuit 151 includes a first number of diodes 1511, and each reverse-conduction circuit 152 includes a second number of diodes 1521. The first number refers to the number of the diodes 1511 in forward series connection, and the second number refers to the number of diodes 1521 in reverse series connection.

Each diode 1511 in the forward-conduction circuit 151 has an anode thereof coupled to a cathode of another diode 1511 to form a series connection structure. The anode of the first diode 1511 in this series connection structure is coupled to the second terminal 120b of the thermal reactive element 120, and the cathode of the last diode 1511 in this series connection structure is coupled to the ground voltage VSS. As such, the forward-connection circuit 151 is connected in parallel to the second terminal 120b of the thermal reactive element 120, and may serve as a path for releasing a positive over-voltage occurring at the second terminal 120b of the thermal reactive element 120.

Thus, when a difference between a positive over-voltage occurring at the second terminal 120b of the thermal reactive element 120 and the ground voltage VSS is greater than a first cut-in voltage formed by the first number of diodes 1511, the positive over-voltage causes these diodes 1511 to be turned on and to clamp the positive over-voltage at the first cut-in voltage. At this point, the first cut-in voltage may be a sum of the on-voltage of the first number of diodes 1511, and the predetermined first cut-in voltage may be achieved through adjusting the first number. For example, assuming that the on-voltage of the diodes 1511 is 0.6 V and the first number is 5, the first cut-in voltage is then 3 V (i.e., the product of the on-voltage and the first number). In this embodiment, five diodes 1511 are in a forward series connection to form one forward-conduction circuit 151 to release the positive over-voltage. Further, to satisfy the requirement of an explosion-proof grade, two identical forward-connection circuits 151 are additionally connected in parallel.

Each diode 1521 of the reverse-conduction circuit 152 has an anode thereof coupled to a cathode of another diode 1521 to form a series connection structure. The cathode of the first diode 1521 in this series connection structure is coupled to the second terminal 120b of the thermal reactive element 120, and the anode of the last diode 1521 in this series connection structure is coupled to the ground voltage VSS. As such, the reverse-conduction circuit 152 is connected in parallel to the second terminal 120b of the thermal reactive element 120, and serves as a path for releasing a negative over-voltage occurring at the second terminal 120b of the thermal reactive element 120.

Thus, when a difference between a negative over-voltage occurring at the second terminal 120b of the thermal reactive element 120 and the ground voltage VSS is greater than a second cut-in voltage formed by the second number of diodes 1521, the negative over-voltage causes these diodes 1521 to be turned on and to clamp the negative over-voltage at the second cut-in voltage. At this point, the second cut-in voltage may be a sum of the on-voltage of the second number of diodes 1521, and the predetermined second cut-in voltage may be achieved through adjusting the second number. For example, assuming that the on-voltage of the diodes 1521 is 0.6 V and the second number is 2, the second cut-in voltage is then 1.2 V (i.e., the product of the on-voltage and the second number). In this embodiment, two diodes 1521 form a reverse-conduction circuit 152 to release the negative over-voltage. Further, to satisfy the requirement of an explosion-proof grade, two identical reverse-connection circuits 152 are additionally connected in parallel.

In some embodiments, for example but not limited to, the first number may be greater than the second number. The first number may also be smaller than or equal to the second number.

In some embodiments, the diode 1511 and the diode 1512 may be diodes having a low-capacitance characteristic, e.g., switch diodes or Schottky diodes, so as to reduce the effect that the diode series circuit 150 has on the high-speed transmission signals on the transmission path between the connection port 130 and the system circuit 110. In other words, apart from using the diode series circuit 150 to suppress the positive or negative over-voltage to enable the electronic device 100 to achieve the standard for intrinsic safety, the low-capacitance characteristic of the diode series circuit 150 may also be used to enhance the signal transmission quality between the connection port 130 and the system circuit 110 of the electronic device 100.

In some embodiments, under conditions that the diode 1511 and the diode 1521 are switch diodes, the Zener voltage (Vz) is a rated value, and the frequency is 1 MHz, the capacitance of the diode 1511 and the diode 1521 is only about 2 picofarad (pF).

In some embodiments, the connection port 130 may be applied to a high-speed transmission interface, and the diode series circuit 150 may use its low-capacitance characteristic to reduce the effect on the high-speed transmission signals on the transmission path between the connection port 130 applied in the high-speed transmission interface and the system circuit 110, e.g., reducing the rising time and falling time of signals, so as to prevent excessive effects on the signals transmitted in the high-speed transmission interface from causing poor performance, malfunctions and false actions of the electronic device 100.

In some embodiments, the high-speed transmission interface may be a USB 2.0 transmission interface, a USB 3.0 transmission interface, a SIM transmission interface or an SDIO transmission interface.

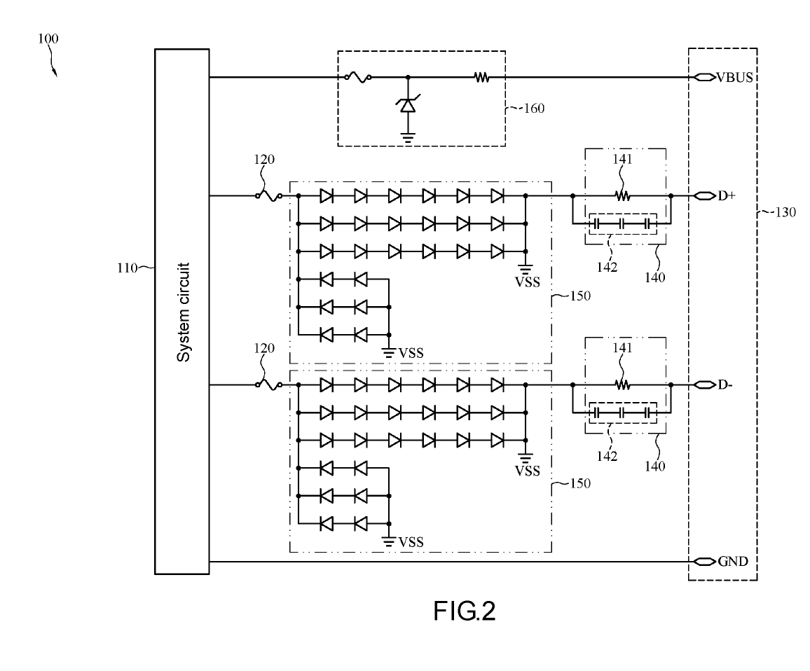

FIG. 2 shows a schematic diagram of a transmission port, applying a USB 2.0 transmission port, of an electronic device according to an embodiment of the present invention. Referring to FIG. 2, the description below is given by the transmission port 130 applying a USB 2.0 transmission interface as an example. In general, the transmission port 130 applying a USB 2.0 transmission interface at least includes four terminals, which may respectively be a power terminal VBUS, a positive data terminal D+, a negative data terminal D−, and a ground terminal GND.

In some embodiments, the electronic device 100 includes two sets of the intrinsic safety protection circuit (which may be formed by the thermal reactive element 120, the current limiting element 140 and at least one diode series circuit 150) according to an embodiment of the present invention. One of the two sets of intrinsic safety protection circuits is disposed on the transmission path, which needs to consider signal transmission quality, between the positive data terminal D+ of the transmission port 130 and the system circuit 110. The other intrinsic safety protection circuit is disposed on transmission path between the negative data terminal D− of the transmission port 130 and the system circuit 110. Moreover, the electronic device 100 may further include a typical intrinsic safety protection circuit 160 (formed by a fuse, a resistor and a Zener diode) that is disposed on the transmission path, which does not need to consider the signal transmission quality, between the power terminal VBUS and the system circuit 110.

In one embodiment, when the system circuit 110 of the electronic device 100 does not output signals to the power terminal VBUS of the transmission port 130, the transmission path between the power terminal VBUS and the system circuit 110 does not need to be provided with the typical intrinsic safety protection circuit 160.

In one embodiment, the system circuit 110, coupled through the intrinsic safety protection circuit to the transmission port 130 applying a USB 2.0 transmission interface, may also be a system circuit applying a USB 2.0 transmission interface. For example, the system circuit 110 may be a central processing unit (CPU), but the present invention is not limited thereto.

In some embodiments, the transmission port 130 applying a USB 2.0 transmission interface may be a POGO connector, but the present invention is not limited thereto.

In some embodiments, the current limiting element 140 may include a resistor 141 and a capacitor group 142. The resistor 141 is coupled between the connection port 130 and the second terminal 120b of the thermal reactive element 120, and the capacitor group 142 is connected in parallel to the resistor 141. At this point, by using characteristics of AC conduction during capacitance transient and open circuit when DC is in stable state to the design for high-speed signals, the capacitor group 142 reduces the effects of the current limiting 140 upon small AC signals and the signal quality of small AC signals.

In some embodiments, the capacitor group 142 may achieve its effect by connecting one or multiple capacitors in series and connecting in parallel to the current limiting element 140 according to a system explosion-proof grade. At this point, as shown in FIG. 2, with respect to a design for an explosion-proof grade, the capacitor group 142 is formed by connecting three capacitors in series. It should be noted that the above number of the capacitors is not construed as a limitation to the present invention.

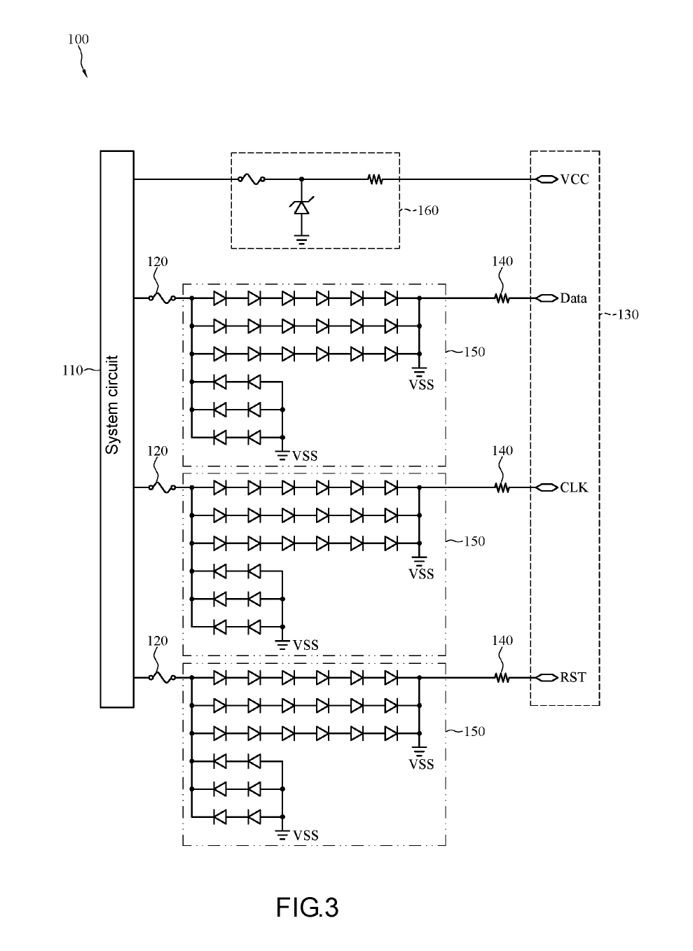

FIG. 3 shows a schematic diagram of a transmission port, applying a SIM transmission interface, of an electronic device according to an embodiment of the present invention. Referring to FIG. 3, in the description below, the transmission port 130 applying a SIM transmission interface is taken as an example. In general, the transmission port 130 applying a SIM transmission interface at least includes four terminals, which may respectively be a data terminal Data, a clock terminal CLK, a reset terminal RST and a power terminal VCC.

In one embodiment, the electronic device 100 includes three sets of the intrinsic safety protection circuit (which may be formed by the thermal reactive element 120, the current limiting element 140, and at least one diode series circuit 150) according to an embodiment of the present invention. At this point, one the three sets of intrinsic safety protection circuits is disposed on the transmission path, which needs to consider the signal transmission quality, between the data terminal Data of the transmission port 130 and the system circuit 110. The other two sets of intrinsic safety protection circuits are respectively disposed on the transmission path between the clock terminal CLK of the transmission port 130 and the system circuit 110, and the transmission path between the reset terminal RST of the transmission port 130 and the system circuit 110. Moreover, the electronic device 100 may further include a typical intrinsic safety protection circuit 160 (formed by a fuse, a resistor and a Zener diode) that is disposed on the transmission path, which does not need to consider the signal transmission quality, between the power terminal VCC and the system circuit 110.

In some embodiments, the system circuit 110 applying a SIM transmission interface may be a WWAN module, but the present invention is not limited thereto.

In some embodiments, the transmission port 130 applying a SIM transmission interface may be Micro SIM slot, but the present invention is not limited thereto.

In some embodiments, the current limiting element 140 may be implemented by a current limiter, but the present invention is not limited thereto.

In conclusion, the electronic device having an output energy limiting function according to the embodiments of the present invention uses a diode series circuit having a low-capacitance characteristic, a current limiting unit and a thermal reactive element to limit the output energy of a connection port, enabling the electronic device to achieve the standard for intrinsic safety protection. Moreover, the diode series circuit having a low-capacitance characteristic further enhances the signal transmission quality between the connection port and the system circuit of the electronic device.

While the invention has been described in terms of what is presently considered to be the most practical and preferred embodiments, it is to be understood that the invention is only illustrative and needs not to be limited to the above embodiments. It should be noted that, equivalent variations and replacements made to the embodiments are to be encompassed within the scope of the present invention. Therefore, the scope of the present invention is to be accorded with the appended claims.

What is claimed is:

1. An electronic device having an output energy limiting function, comprising:
a system circuit;
a thermal reactive element, having a first terminal thereof coupled to the system circuit;
a connection port;
a current limiting element, coupled between a second terminal of the thermal reactive element and the connection port; and
at least one diode series circuit, coupled between the second terminal and a ground voltage.

2. The electronic device having an output energy limiting function according to claim 1, wherein the thermal reactive element comprises at least one of a fuse element, a dual-metal element, a shape memory alloy and the combination thereof.

3. The electronic device having an output energy limiting function according to claim 1, wherein the at least one diode series circuit comprises at least one forward-conduction circuit, and each forward-conduction circuit is coupled between the second terminal and the ground voltage and comprises a first number of diodes connected in series.

4. The electronic device having an output energy limiting function according to claim 3, wherein the at least one diode series circuit comprises at least one reverse-conduction circuit, and each reverse-conduction circuit is coupled between the second terminal and the ground voltage and comprises a second number of diodes connected in series.

5. The electronic device having an output energy limiting function according to claim 4, wherein an anode of one of the first number of diodes is coupled to the second terminal, a cathode of one of the first number of diodes is coupled to the ground voltage, an anode of one of the second number of diodes is coupled to the ground voltage, and a cathode of one of the second number of diodes is coupled to the second terminal.

6. The electronic device having an output energy limiting function according to claim 4, wherein the second number is smaller than the first number.

7. The electronic device having an output energy limiting function according to claim 1, wherein the connection port is applied to a high-speed transmission interface.

8. The electronic device having an output energy limiting function according to claim 7, wherein the high-speed transmission interface comprises a USB 2.0 transmission interface, a USB 3.0 transmission interface, a SIM transmission interface and an SDIO transmission interface.
